(19) United States
(12) Patent Application Publication
(10) Pub. No.: US 2006/0131424 A1
(43) Pub. Date: Jun. 22, 2006

(54) Article comprising an integrated marking tag and a mark-detection device

(75) Inventors: Philippe Helin, Coudun (FR); Pascal Ransch, Meylan (FR)

Correspondence Address: BURR & BROWN, PO BOX 7068, SYRACUSE, NY, 13261-7068, US

(73) Assignee: MEMSCAP, Bernin (FR)

(21) Appl. No.: 11/343,040

(22) Filed: Jan. 30, 2006

Related U.S. Application Data
(63) Continuation of application No. PCT/FR04/50384, filed on Aug. 19, 2004.

(30) Foreign Application Priority Data
Aug. 22, 2003 (FR) 0350449

(51) Int. Cl. G06K 19/00; G06K 19/06

(52) U.S. Cl. 235/487; 235/491

(57) ABSTRACT

The invention relates to a marking device (1) comprising an element which is made from a semi-conductor material having patterns (2-4, 12-14) which are hollowed out of the face thereof, the arrangement of said patterns being representative of at least one piece of information. The depth of the patterns (2-4, 12-14) can vary from one pattern to another and can adopt a plurality of different values which are representative of an additional piece of information. The invention also relates to an apparatus which is used to detect such marks and to articles having a marking device of said type integrated into the material forming same.

### TECHNICAL FIELD

The present invention relates to a tag that can be used to mark a very wide variety of articles with a view to ensuring, in particular, their identification in order, for example, to be able to monitor their circulation in the market. It relates, more particularly, to a marking tag comprising an arrangement of patterns, the geometry of which represents coded information.

The invention also relates to a mark-detection device designed to analyse this type of marking tag.

The invention relates more especially to a new architecture for this type of marking tag which increases the number of information items that can be coded in a marking tag very considerably without increasing the dimensions of said tag.

It also relates to achieving an extremely high level of security by very effectively limiting any risk of counterfeiting.

### DESCRIPTION OF THE PRIOR ART

For some industrial or manufactured products, it may be important or even absolutely vital to make sure that each article that is marketed is identified. In fact, in some cases the manufacturer may need to be able to access information relating to a particular article, for example in order to check whether that article has a best-before date or whether the article is being distributed via those networks in which the manufacturer initially placed it. In this respect, distribution can be organised so that available quantities and pricing are appropriate to a given market but differ, for instance, from the prices set in a different distribution network.

In order to prevent products intended for a distribution channel entering a different channel, it is necessary that each article is fitted with a marking tag that makes it possible to identify the origin or destination as defined by the manufacturer.

Nowadays there are bar code marking devices which nevertheless have the drawback of being relatively easy to counterfeit by using commonly available printing equipment.

One problem which the invention aims to solve is that of improving the security of these marking tags by making them almost impossible to counterfeit, at least at a cost that is not disproportional to the value of the marked articles.

Also, the number of information items that can be coded in a bar code system is relatively small and may not suffice to identify articles that are produced in high volumes.

In order to increase the quantity of information that is coded in a bar code type system, the suggestion has been made to organise the coding in the form of a matrix as described, in particular, in Document U.S. Pat. No. 3,532,859. Each box in such a matrix therefore contains a binary value so that information is coded in two directions.

Coding systems have also been suggested in the field of the electronics industry. For example, the tag described in Document EP 1 073 097 relates to a marking tag intended to identify semiconductor wafers used in manufacturing processes for electronic components. Such a tag therefore comprises patterns produced on the surface of the semiconductor, the layout of these patterns corresponding to the encoding of a certain number of information items.

Another example of a marking tag is described in Document DE 198 47 247. More precisely, this tag comprises a set of patterns hollowed out of the surface of the semiconductor material in a bidirectional layout.

One object of the invention is to perfect this specific type of marking by increasing the density of the information that can be recorded in a set of patterns produced on a substrate made of a semiconductor material.

### SUMMARY OF THE INVENTION

The invention therefore relates to an article comprising an integrated marking tag on the surface of which patterns are hollowed out, the layout of these patterns being representative of at least one information item.

According to the invention, the marking tag is embedded in the material that constitutes the article. In addition, it comprises patterns, the depth of which varies from one pattern to another. This depth may assume a plurality of different values that are representative of an additional information item.

Thus, the marking tag is incorporated into the article to be identified and this prevents removal of the marking tag without partially destroying the area of the article that encloses it.

In other words, each of the patterns of the marking tag has a depth which can be varied, unlike known systems according to the prior art whereby the depth of each pattern is fixed and has a single predetermined value or a zero value. In contrast, the invention makes it possible to give this depth a multitude of intermediate values depending on the information to be coded.

The maximum number of information items that can be coded therefore depends not only on the number of patterns that can be produced on a given surface but also on the number of different depth levels which each pattern can have. In other words, coding is performed three dimensionally in accordance with the invention.

In practice, the patterns may have a matrix-like distribution, typically organised in a square or rectangular shape. However, the scope of the invention also includes other configurations in which the patterns are distributed in any general shape whatsoever.

It is apparent that the invention significantly improves coding and identification security because these marking tags are virtually tamperproof. In fact, whereas it is apparent that a matrix-type representation can be reproduced by a printing process, it is impossible, using such printing techniques, to simulate the depth of patterns which can be verified by viewing at variable incidence.

In practice, the marking tag can be made of various materials as long as they are compatible with the material that constitutes the article and its manufacturing processes. In order to fabricate glass-based articles, one might opt for marking tags based on a semiconductor material, quartz or sapphire because these materials are very resistant to the high temperatures generally encountered during glass casting or glass blowing processes. The distinctive patterns are not degraded when the marking tag is integrated into the article made of glass. But if the article has to be made of a thermoplastic polymer, it is possible to use marking tags based on other materials such as metal or other thermosetting materials.

In cases where marking tags based on a semiconductor material are used, the patterns may be produced in various ways, especially by using anisotropic wet etching with humic acids or dry etching processes, especially Deep Reactive Ionic Etching (DRIE) or any other process that makes it possible to obtain a variable depth level.

If an anisotropic chemical etching process is used, selecting an appropriate semiconductor substrate with the right crystallographic planes makes it possible to obtain patterns with a defined geometry. In the case of a silicon substrate having a principal plane which is parallel to the crystallographic planes (100), the patterns are formed by truncated pyramids having a height—which is therefore equivalent to the depth of the patterns—, which is adjusted depending on the duration of the etching stage.

Patterns can also be formed by the stacking of truncated pyramids obtained by a succession of sequenced etching stages.

This type of marking tag can be incorporated into many articles in order to allow their identification.

Advantageously and in practice, the marking tag may form part of the wall that retains liquid inside a bottle so that any attempt to remove the marking tag will damage the integrity of the bottle, thereby causing leakage of the liquid that it contains and loss of its market value.

The invention also relates to a mark-detection device which is suitable for analysing the marking tags described above. These detection devices comprise means of assessing the depth of each pattern of a marking tag. These means may operate by emitting an electromagnetic wave, preferably but not necessarily in the visible region, and by analysing the image reflected by the marking tag.

In one particular embodiment, the depth of each pattern can be ascertained by assessing the contrast of the image of each pattern, viewed at a specific incidence. In this way, if the patterns have a truncated pyramid shape, the lateral sides and the trough of the truncated pyramid do not reflect light in the same direction and are therefore displayed differently.

The contrast of the reflected image is therefore representative of the ratio of the sizes of the sides to the sizes of the troughs of the pyramids and this ratio is itself linked to the depth of the patterns.

### BRIEF DESCRIPTION OF THE DRAWINGS

The way in which the invention is embodied and its resulting advantages will become more apparent from the description of an embodiment, reference being made to the accompanying drawings in which:

FIG. 1 is a schematic front view of a marking tag in accordance with the invention.

FIGS. 2 and 3 are cross-sectional views along planes II and III respectively in FIG. 1.

FIGS. 3a and 3b are cross-sectional views corresponding to FIG. 3 showing the successive stages of etching in order to achieve the configuration shown in FIG. 3.

FIG. 4 is a schematic view showing an article fitted with a marking tag and the associated viewing system.

FIG. 5 is a cross-sectional view of the article in FIG. 4 showing a method of fitting the marking tag.

### DESCRIPTION OF THE PREFERRED EMBODIMENTS

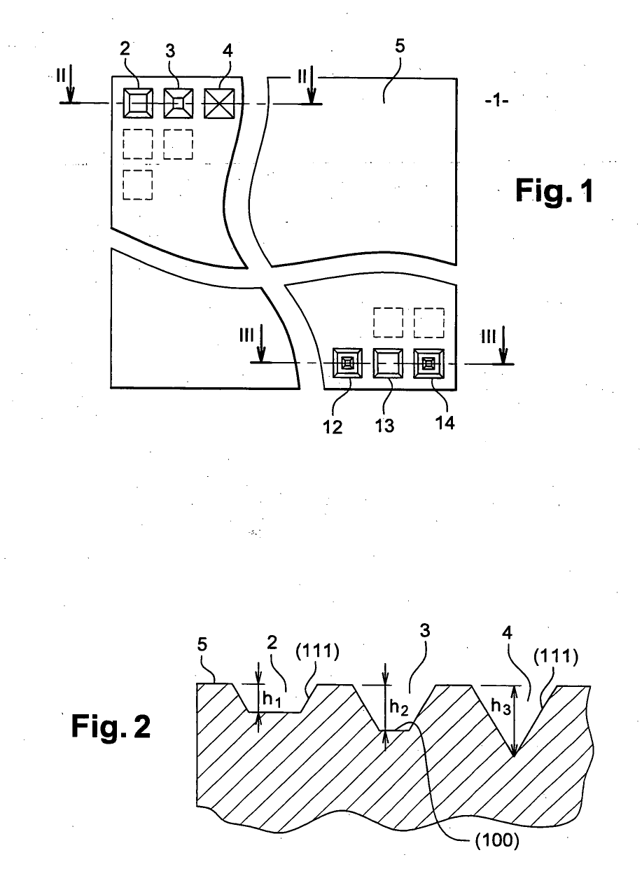

As already stated, the invention relates to a marking tag which makes it possible to identify a very wide variety of different types of products An example of this marking tag is shown in FIG. 1. This tag (1) is in the form of an element made of a semiconductor material, typically silicon. This tag (1) comprises a plurality of patterns (2, 3, 4) which are produced on its upper surface (5). In the form shown, these patterns (2-4) have a generally square shape and are arranged in a matrix-like layout.

Nevertheless, the scope of the invention also covers alternative embodiments in which the individual patterns each assume different shapes and may be arranged in any non-matrix like manner.

In the form shown, each of the patterns (2-4) has a variable depth (h₂, h₃, h₄), these depths (h₂-h₄) being capable of assuming different values. In this way, the coding options associated with this marking tag depend not only on the dimensions of the matrix, i.e. the number of patterns, but also on the number of intermediate depth levels which each pattern may have.

Various methods can be used to obtain such patterns, especially that shown in FIG. 2. In this case, because the substrate used is a silicon substrate with (100) crystallographic orientation, a first mask which makes it possible to define the general shape of the patterns is deposited by photolithography.

A wet anisotropic etching stage is then performed, typically using KOH. This etching makes it possible to define truncated pyramids because the crystallographic stop planes are the (111) planes. This first etching stage makes it possible to define the first depth level. A second mask which is preserved only in the area of patterns having a depth which must be preserved at this first intermediate value is subsequently deposited. A second KOH etching stage makes it possible to increase the depth of the non-masked patterns (3, 4). These additional mask deposition and etching stages are repeated as many times as necessary in order to obtain all the patterns in the desired layout.

Depending on the initial window of the patterns, etching may extend as far as the junction of the (111) crystallographic planes, as is the case for pattern (4).

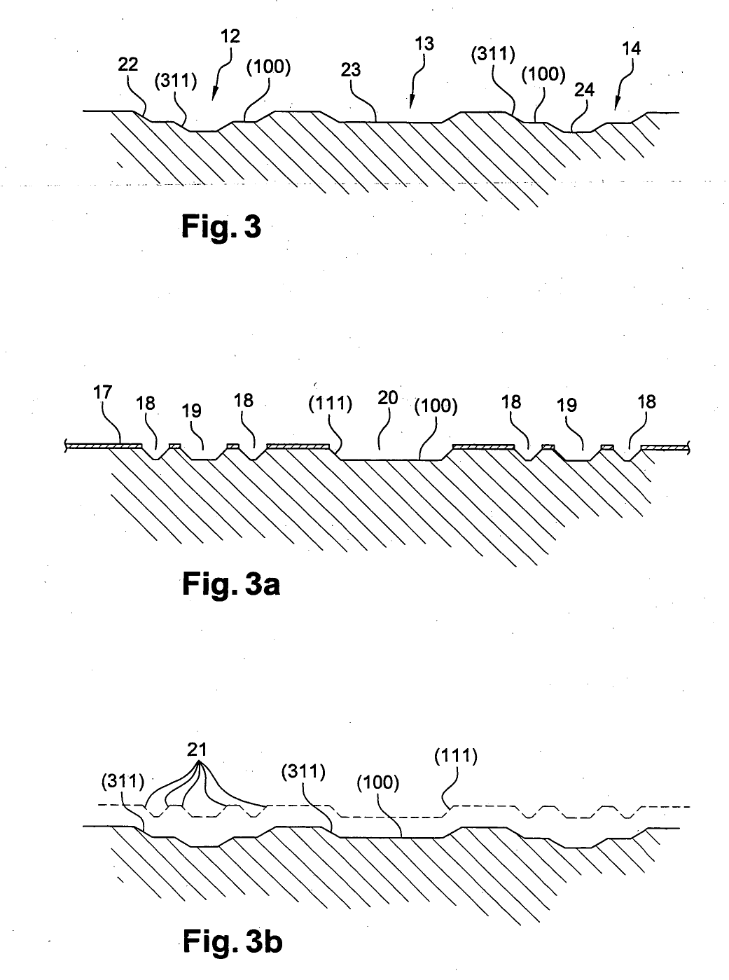

It is also possible, as shown in FIGS. 3, 3a and 3b, to use a single etching mask associated with two chemical etching stages. More precisely, as shown in FIG. 3a, there is an initial chemical etching stage in the presence of a mask (17) which makes it possible to define incipient patterns (18-20), including faces sloping along the (111) planes and flat areas parallel to the (100) planes. Subsequently, the etching mask is removed and, as shown in FIG. 3b, a second chemical etching stage is performed, typically using KOH. The incipient patterns (18-20) are then etched in accordance with the instructions in the document entitled “Novel micro machine technology for multi level structures of silicon” by Minhang Dao, Xinxin Li, Shaogun Shen and Hong Shen, published in Sensors and Actuators A63 (1997), pages 217 to 221.

This second etching stage uses the considerable etching selectivity along the (311) planes which exists in the area of the convex crests (21) that are formed in the area of the boundaries of the incipient patterns (18-20). This particular fabrication method therefore makes it possible to form patterns which, as shown in FIG. 3, are stacked truncated pyramids having sloping faces (22) parallel to the (311) planes and also level areas (23) that are parallel to the principal plane (100) of the substrate or even, in a configuration that is not shown, regions defined by the (111) stop planes of the silicon if the etching time is shorter.

The layout of the various patterns (2-4, 12-14) on the surface of the marking tag (1) can be devised to ensure various types of coding, including, in particular, redundant patterns or even patterns that are used to define the reading direction. Certain areas of the marking tag can be assigned to different codes such as a particular identification number or a definition of the product that is intended to carry the marking tag.

Subsequently, the silicon substrate may undergo various processes intended to facilitate its use or protect it from its external environment. For example, depositing metallisation, oxide or nitride layers may make it possible to improve the reflectiveness of the patterns thus etched. It is also possible to protect the substrate by capping it by means of a soldering or wafer bonding stage.

Obviously, the patterns described above can be produced using different processes and may also have different geometries when other etching processes are used. Depth variations can also be obtained by using dry etching operations, especially DRIE, for instance by using a special mask obtained using the known grey-scale lithography technique.

As already stated, the invention relates to a mark-detection device which analyses the image of the marking tag. This image can be used in the visible radiation region but also in the invisible radiation region if the marking tag is covered with a surface which is reflective at the wavelength that is used.

Analysis of this image makes it possible to detect any difference in intensity between the sloping faces of the patterns (2-4) and the troughs of the same patterns. The overall contrast of the image of each pattern therefore represents the ratio of the surface area of the troughs of the patterns—viewed at an incidence that is substantially perpendicular—to the surface areas of the sloping faces that are further from an incidence that is substantially zero.

It should also be noted that the fact that the patterns are three dimensional makes it possible, by moving away from a zero incidence, to obtain different images of opposite sloping faces of a single pattern. By varying this incidence, it is therefore possible to confirm that the pattern is actually three dimensional, thus detecting any attempted counterfeiting using flat images that represent patterns viewed at zero incidence.

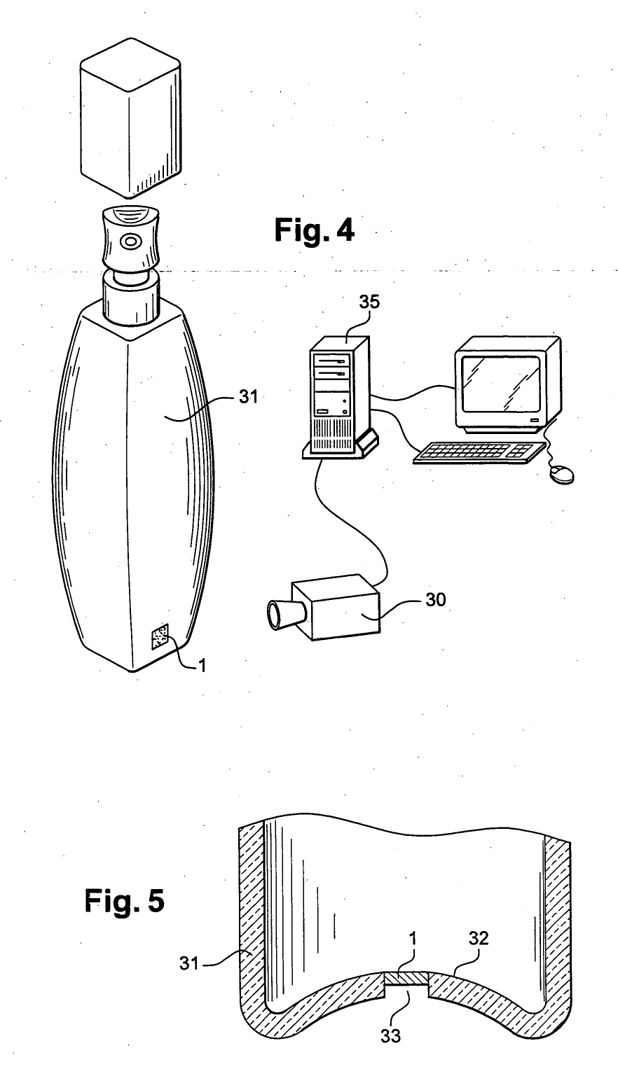

This marking tag may, in particular, be used as shown in FIG. 4 incorporated into a container (31) intended to contain a liquid. In this case, the marking tag (1) can be embedded inside the material that forms one of the walls of the container (31). It should be noted that, usefully, marking tags made of silicon are compatible with glass casting processes.

Tampering with such a marking tag embedded inside the material of the container is highly risky because it damages the actual material of the container (31) and is therefore very easy to detect. This risk of tampering can be reduced still further if, as shown in FIG. 5, the marking tag (1) constitutes part of the wall (32) of the container that contains the liquid.

In this case, removing the marking tag (1) creates an opening between the inside of the container and its external environment in the form of a protective channel (33). It is apparent that the container will no longer be leaktight and it will therefore no longer have any market value.

In practice, the mark-detection device (30) can be connected to a data processing system (35) which includes, in particular, a database. This database can be loaded in a data acquisition system associated with the detection device or even be remotely accessible via a data network of any kind.

The above description shows that the marking tag according to the invention has many advantages, especially that of enabling an extremely large number of coding possibilities. More precisely, this number is of the order of p^{n×m} where p is the number of possible different depth values and n and m are the numbers of rows and columns if patterns are organised as a matrix, i.e. 3^{8×8}=3⁶⁴≈3,4.10³⁰ combinations for a tag having a total surface area of the order of one square millimetre comprising 8 rows and 8 columns of patterns that can assume 3 different depth levels, i.e. zero depth, maximum depth and intermediate depth.

Such a marking tag is especially attractive in terms of security because it is almost impossible to counterfeit. Using a semiconductor material makes it possible to incorporate the marking tag in many articles, including those made of a material which is produced at extremely high temperature, especially glass. Nevertheless, for other types of articles produced at less high temperatures, other materials can be used, in particular materials based on metal or thermoplastic or thermosetting polymers.

1. An article comprising an integrated marking tag (1) on the surface of which patterns (2-4) are hollowed out, the layout of these patterns being representative of at least one information item, characterised in that the marking tag is embedded in the material that constitutes the article and in that it comprises variable-depth patterns, said depth (h2-h4) of patterns (2-4) being able to assume a plurality of different values that represent an additional information item.

2. An article as claimed in claim 1, characterised in that the patterns (2-4) are distributed in a matrix-like manner.

3. An article as claimed in claim 1, characterised in that the patterns (2-4) are formed by truncated pyramids.

4. An article as claimed in claim 1, characterised in that the patterns (22-24) are formed by stacked truncated pyramids.

5. An article as claimed in claim 1, characterised in that the marking tag is produced from a semiconductor material.

6. An article as claimed in claim 5, characterised in that the patterns (2-4) are produced by wet anisotropic chemical etching.

7. An article as claimed in claim 5, characterised in that the patterns are produced by dry etching, especially by deep reactive ionic etching.

8. An article as claimed in claim 1, of the type intended to contain a liquid, characterised in that the marking tag forms part of the wall (32) that retains the liquid.

9. A mark-detection device (30) suitable for analysing an article as claimed in claim 1, characterised in that it comprises means of evaluating the depth of each pattern of a marking tag.

10. A mark-detection device as claimed in claim 9, characterised in that the means of evaluating the depth of each pattern determine the image contrast of each pattern (2-4) viewed at a determined incidence.
